(19) United States
(12) Patent Application Publication
(10) Pub. No.: US 2020/0026131 A1
(43) Pub. Date: Jan. 23, 2020

(54) LIQUID CRYSTAL DEVICE AND ELECTRONIC APPARATUS

(71) Applicant: SEIKO EPSON CORPORATION, Tokyo (JP)

(72) Inventor: Naoki TOMIKAWA, Suwa-gun (JP)

(73) Assignee: SEIKO EPSON CORPORATION, Tokyo (JP)

(21) Appl. No.: 16/517,993

(22) Filed: Jul. 22, 2019

(30) Foreign Application Priority Data
Jul. 23, 2018 (JP) 2018-137482

(51) Int. Cl. G02F 1/1343; G09G 3/36; G02F 1/1337; G02F 1/1339

(52) U.S. Cl. CPC G02F 1/134309; G09G 3/3614; G09G 2300/0426; G02F 1/1339; G02F 1/1337

(57) ABSTRACT

In a liquid crystal device, in an area located between a pixel area and a sealing material in plan view in a first substrate, a first electrode, a second electrode, and a third electrode are provided sequentially from the pixel area toward the sealing material, the first electrode being supplied with a first signal, the second electrode being supplied with a second signal having a phase different from the first signal, and the third electrode being supplied with a third signal having a phase different from those of the first signal and the second signal. Here, a distance (first distance) from a pixel electrode, which is adjacent to the first electrode, among a plurality of pixel electrodes to the first electrode is equal to or less than a distance (second distance) from the first electrode to the second electrode.

The present application is based on, and claims priority from JP Application Serial Number 2018-137482, filed on Jul. 23, 2018, the disclosure of which is hereby incorporated by reference herein in its entirety.

### BACKGROUND

### 1. Technical Field

The present disclosure relates to a liquid crystal device and an electronic apparatus.

### 2. Related Art

The liquid crystal device includes a liquid crystal panel in which a liquid crystal layer is held between a pair of substrates. When light is incident on the liquid crystal panel, a liquid crystal material or the like used for the liquid crystal layer may undergo photochemical reactions and ionic impurities may be generated. In addition, in the manufacturing process of the liquid crystal device, ionic impurities may enter the liquid crystal layer from the sealing material or the like. On the other hand, in a case where the alignment state of the liquid crystal molecules changes and flow is generated in the liquid crystal layer when the liquid crystal device is driven, the ionic impurities aggregate to the end portions of the pixel areas and the degradation of display quality of image such as image persistence (stain) or the like occurs. In this respect, JP-A-2015-1634 proposes a technology in which a first electrode is provided between a pixel area and a sealing material, a second electrode is provided between the first electrode and the sealing material, and alternating signals with different phases are applied to the first electrode and the second electrode to sweep out the ionic impurities in the pixel area to the outside of the pixel area.

The technique described in JP-A-2015-1634 has a problem in that, when alternating signals with different phases are applied to the first electrode and the second electrode to sweep out the ionic impurities to the outside of the pixel area, ionic impurities having low mobility cannot follow the change in potential of the first electrode and the second electrode, and the ionic impurities cannot be swept outside the pixel area. In particular, in the case of the aspect described in JP-A-2015-1634, a distance from the first electrode to a pixel electrode adjacent to the first electrode of the plurality of pixel electrodes is greater than the distance from the first electrode to the second electrode at the end portion of the pixel area. Thus, the problem in that ionic impurities having low mobility cannot sweep outside of the pixel area is more likely to arise.

### SUMMARY

In view of the problem described above, an object of the present disclosure is to provide a liquid crystal device capable of sweeping out ionic impurities having low mobility from the pixel area to the outside, and an electronic apparatus.

To solve the problem described above, a liquid crystal device according to the present disclosure includes a first substrate, a second substrate bonded to the first substrate via a sealing material, a liquid crystal layer disposed in a space surrounded by the sealing material between the first substrate and the second substrate, a plurality of pixel electrodes provided in a pixel area in the first substrate, a first electrode provided at one of the first substrate and the second substrate and supplied with a first signal in an area located between the pixel area and the sealing material in plan view, and a second electrode provided at the one of the first substrate and the second substrate and supplied with a second signal having a phase different from that of the first signal in an area located between the first electrode and the sealing material in plan view, wherein a first distance being a distance from a pixel electrode, which is adjacent to the first electrode, among the plurality of pixel electrodes to the first electrode is equal to or less than a second distance from the first electrode to the second electrode.

In the present disclosure, the first electrode is provided between the pixel area, and the sealing material and the second electrode is provided between the first electrode and the sealing material. The signals having phases differing from each other are applied to the first electrode and the second electrode. With this configuration, it is possible to draw the ionic impurities in the pixel area to the first electrode, and then to the second electrode. Thus, the ionic impurities can be swept out to outside the pixel area. In addition, since the distance (first distance) from the pixel electrode to the first electrode is equal to or less than the distance (second distance) from the first electrode to the second electrode, ionic impurities having a low mobility can be swept out from the pixel area toward the first electrode, even when the frequency of the signal applied to the first electrode and the second electrode is not excessively low.

### BRIEF DESCRIPTION OF THE DRAWINGS

FIG. 1 is an explanatory view schematically illustrating a planar configuration of a liquid crystal device according to First Exemplary Embodiment of the present disclosure.

FIG. 2 is a schematic cross-sectional view taken along the line H-H′ of the liquid crystal device illustrated in FIG. 1.

FIG. 3 is an equivalent circuit diagram illustrating an electrical configuration of the liquid crystal device illustrated in FIG. 1.

FIG. 4 is a cross-sectional view schematically illustrating a structure of a pixel illustrated in FIG. 3.

FIG. 5 is an explanatory view schematically illustrating the behavior of ionic impurities in the liquid crystal device illustrated in FIG. 1.

FIG. 6 is an explanatory view illustrating a pixel area in the liquid crystal device illustrated in FIG. 1.

FIG. 7 is a cross-sectional view schematically illustrating a state in which a liquid crystal panel is cut along the line A-A′ in FIG. 6.

FIG. 8 is an explanatory view illustrating a first example of the signal used in an ion trap mechanism illustrated in FIG. 7.

FIG. 9 is an explanatory view illustrating a second example of the signal used in the ion trap mechanism illustrated in FIG. 7.

FIG. 10 is an explanatory view illustrating a third example of the signal used in the ion trap mechanism illustrated in FIG. 7.

FIG. 11 is a graph illustrating the relationship between mobility and temperature of ionic impurities in a liquid crystal layer.

FIG. 12 is a circuit diagram illustrating a configuration for producing the signal illustrated in FIG. 8 and the like.

FIG. 13 is an explanatory view illustrating a relationship between the configuration of an ion trap electrode illustrated in FIG. 6 and effect of sweeping the ionic-impurity.

FIG. 14 is an explanatory view of a liquid crystal device according to Second Exemplary Embodiment of the present disclosure.

FIG. 15 is an explanatory view of a liquid crystal device according to Third Exemplary Embodiment of the present disclosure.

FIG. 16 is an explanatory view of a liquid crystal device according to Fourth Exemplary Embodiment of the present disclosure.

FIG. 17 is an explanatory view of a liquid crystal device according to Fifth Exemplary Embodiment of the present disclosure.

FIG. 18 is an explanatory view illustrating a first configuration example of an electronic apparatus (projection-type display device) to which the present disclosure is applied.

FIG. 19 is an explanatory view illustrating a second configuration example of an electronic apparatus (projection-type display device) to which the present disclosure is applied.

### DESCRIPTION OF EXEMPLARY EMBODIMENTS

The exemplary embodiments according to the present disclosure will be described with reference to the drawings below. Note that, in the drawings referred below, illustrations are given in enlarged or reduced states as appropriate so that portions described can be easily recognized. In addition, in the description below, when films or the like formed on a one-side surface 10s of a first substrate 10 are described, the upper layer means a side opposite to the side on which the first substrate 10 is located, and the bottom layer side means a side on which the first substrate 10 is located. When films or the like formed on a one-side surface 20s of a second substrate 20 are described, the upper layer means the side opposite to the second 20, and the bottom layer means the second substrate 20 side. Moreover, the “plan view” means a state as viewed from a normal direction with respect to the first substrate 10 and the second substrate 20. Furthermore, in the description below, description will be mainly of an active matrix type liquid crystal device 100 having a thin film transistor (TFT) 30 as one example of a transistor, the thin film transistor serving as a pixel switching element. The liquid crystal device 100 can be used favorably as light modulation means (liquid crystal light valve) or the like of a projection-type display device (liquid crystal projector) described below.

### First Exemplary Embodiment

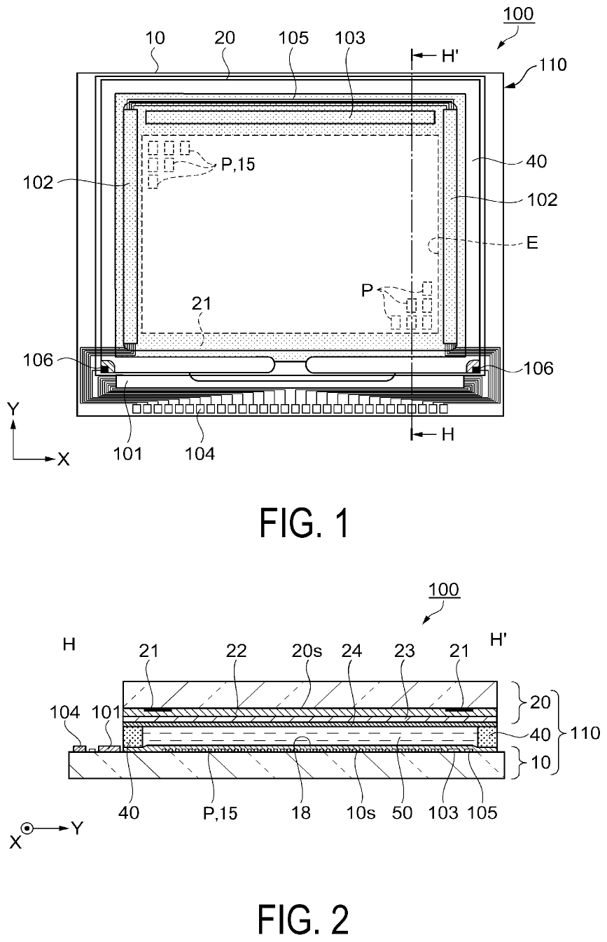

FIG. 1 is an explanatory view schematically illustrating a planar configuration of a liquid crystal device 100 according to First Exemplary Embodiment of the present disclosure. FIG. 2 is a cross-sectional view schematically illustrating a state of the liquid crystal device 100 illustrated in FIG. 1 taken along the H-H′ line. The liquid crystal device 100 illustrated in FIGS. 1 and 2, includes a first substrate 10, and a second substrate 20 facing the first substrate 10, and the first substrate 10 and the second substrate 20 are bonded together being intervened by a frame-shaped sealing material 40. In addition, a liquid crystal layer 50 is held in a space located between the first substrate 10 and the second substrate 20 and surrounded by the sealing material 40. The first substrate 10 and the second substrate 20 are made of a light-transmissive substrate such as a quartz substrate or a glass substrate.

The first substrate 10 is larger than the second substrate 20, and the sealing material 40 is disposed along an outer edge of the second substrate 20. The liquid crystal layer 50 is made of liquid crystal material having positive or negative dielectric anisotropy. The sealing material 40 is made of an adhesive such as an epoxy resin that is thermosetting or ultraviolet-curable, and includes a spacer (not illustrated) for maintaining a constant space between the first substrate 10 and the second substrate 20.

A pixel area E is provided in an area surrounded by the sealing material 40, and a plurality of pixels P are arranged in a matrix manner in the pixel area E. The second substrate 20 is provided with a demarcation portion 21 provided between the sealing material 40 and the pixel area E to surround the periphery of the pixel area E. The demarcation portion 21 is made of a light shielding layer constituted by metal, metal oxide, or the like. Although not illustrated, the light-shielding layer may be configured as a black matrix that overlaps with boundary portions of adjacent pixels P in plan view with respect to the second substrate 20.

A plurality of terminals 104 are arranged along one side between the sealing material 40 and the pixel area E on a one-side surface 10s of the first surface 10 that faces the second substrate 20, and a data-line driving circuit 101 is provided between the terminals 104 and the pixel area E. On the one-side surface 10s of the first substrate 10, a scanning-line driving circuit 102 is provided between the sealing material 40 and the pixel area E along each of two sides adjacent to the side on which the terminals 104 are arranged, and an inspection circuit 103 is provided along the side opposite to the side where the terminals 104 are arranged. On the one-side surface 10s of the first substrate 10, a plurality of wiring lines 105 that couple two scanning-line driving circuits 102 are provided between the sealing material 40 and the inspection circuit 103. The wiring lines coupled to the data-line driving circuit 101 and the scanning-line driving circuit 102 are each coupled to the plurality of terminals 104. Hereinafter, a direction in which the terminals 104 are arranged is referred to as an X direction, and a direction orthogonal to the X direction is referred as a Y direction. Note that the inspection circuit 103 may be provided between the data-line driving circuit 101 and the pixel area E.

A pixel electrode 15 disposed for each of the plurality of pixels P and a first alignment film 18 covering the pixel electrode 15 are provided on the one-side surface 10s side of the first substrate 10. In addition, although not illustrated, a pixel switching element, wiring lines, and the like described below are provided on the one-side surface 10s side, which is the liquid crystal layer 50 side, of the first substrate 10. The pixel electrode 15 is made of a light-transmissive conductive film such as Indium Tin Oxide (ITO).

The demarcation portion 21, a flattening film 22 covering the demarcation portion 21, a common electrode 23 covering the flattening film 22, and a second alignment film 24 covering the common electrode 23 are provided on a one-side surface 20s side, which faces the first substrate 10, of the second substrate 20. The demarcation portion 21 surrounds the periphery of the pixel area E in plan view and overlaps with the scanning-line driving circuit 102 and the inspection circuit 103. With this configuration, light that is incident on the scanning-line driving circuit 102 and the like from the second substrate 20 side is blocked to prevent malfunction due to light. In addition, the demarcation portion 21 prevents unwanted stray light from being incident on the pixel area E to enhance the contrast of the displayed image. The flattening film 22 is made of inorganic material such as silicon oxide, for example.

The common electrode 23 is made of a light-transmissive conductive film such as ITO, and is electrically coupled to a vertical conduction portion 106 provided on the second substrate 20. The vertical conduction portion 106 is electrically coupled to the terminals 104 through the wiring lines provided on the first substrate 10.

The first alignment film 18 and the second alignment film 24 are selected based on the optical design of the liquid crystal device 100. The first alignment film 18 and the second alignment film 24 are made of an inorganic alignment film such as SiOx (silicon oxide) deposited through a vapor phase epitaxy method, and in these films, liquid crystal molecules having negative dielectric anisotropy are substantially vertically aligned. The first alignment film 18 and the second alignment film 24 may be made of an organic alignment film such as polyimide having a surface being rubbed, and in the organic alignment film, liquid crystal molecules having positive dielectric anisotropy are substantially horizontally aligned.

The liquid crystal device 100 according to the present exemplary embodiment is a transmissive type, and is configured as a liquid crystal device in a normally-white mode in which the transmittance of the pixel P becomes the maximum in a state where voltage is not applied or in a normally-black mode in which the transmittance of the pixel P becomes the minimum in a state where voltage is not applied, depending on the optical design of each of the polarization elements disposed on the light incident side and the light-emitting side with respect to the liquid crystal panel 110. The present exemplary embodiment mainly describes an example in which an inorganic alignment film is used for the first alignment film 18 and the second alignment film 24; a liquid crystal material having negative dielectric anisotropy is used for the liquid crystal layer 50; and the normally-black mode is employed for the optical design.

Electrical Configuration

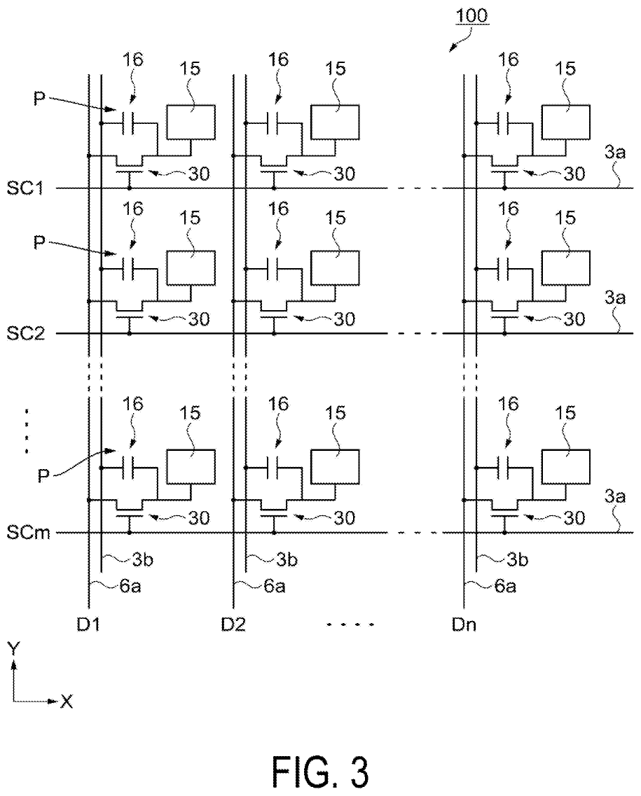

FIG. 3 is an equivalent circuit diagram illustrating an electrical configuration of the liquid crystal device 100 illustrated in FIG. 1. As illustrated in FIG. 3, the liquid crystal device 100 includes at least a plurality of scanning lines 3a extending in the X direction in the pixel area E, and a plurality of data lines 6a extending in the Y direction. The scanning line 3a and the data line 6a are in an insulated state from each other in the first substrate 10. In the present exemplary embodiment, the first substrate 10 includes a capacitor line 3b that extends along the data line 6a. In addition, each pixel P is provided to correspond to each intersection between the plurality of scanning lines 3a and the plurality of data lines 6a. Each of the plurality of pixels P includes a pixel electrode 15, a TFT 30, and a storage capacitor 16. The scan line 3a is electrically coupled to a gate of the TFT 30, and the data line 6a is electrically coupled to a source of the TFT 30. The pixel electrode 15 is electrically coupled to a drain of the TFT 30.

The data line 6a is coupled to the data-line driving circuit 101 illustrated in FIG. 1, and is used to supply the pixel P with image signals D1, D2, . . . , and Dn supplied from the data-line driving circuit 101. The scanning line 3a is coupled to the scanning-line driving circuit 102 illustrated in FIG. 1, and is used to sequentially supply the pixel P with scanning signals SC1, SC2, . . . , and SCm supplied from the scanning-line driving circuit 102. The image signals D1 to Dn supplied from the data-line driving circuit 101 to the data line 6a may be line-sequentially supplied in this order, or may be supplied to the plurality of data lines 6a adjacent to one another on a group basis. The scanning-line driving circuit 102 line-sequentially supplies the scan signals SC1 to SCm to the scan lines 3a at predetermined timing.

In the liquid crystal device 100, during a period of time when the TFT 30, which serves as a switching element, is in a turned-on state in response to input of the scanning signals SC1 to SCm, the image signals D1 to Dn supplied from the data line 6a are written in the pixel electrodes 15 at predetermined timing. The image signals D1 to Dn at a predetermined level written in the liquid crystal layer 50 through the pixel electrodes 15 are maintained for a certain period of time between the pixel electrodes 15 and the common electrode 23 disposed to face the pixel electrodes 15 being intervened by the liquid crystal layer 50. The frequency of the image signals D1 to Dn is 60 Hz, for example. In the present exemplary embodiment, a storage capacitor 16 is coupled in parallel to a liquid crystal capacitor formed between the pixel electrode 15 and the common electrode 23 to prevent the image signals D1 to Dn maintained between the pixel electrode 15 and the liquid crystal layer 50, from leaking. The storage capacitor 16 is provided between the drain of the TFT 30 and the capacitor line 3b.

The inspection circuit 103 illustrated in FIG. 1 is coupled to the data line 6a, and is used to detect the image signals described above during a manufacturing process for the liquid crystal device 100, to check operation defects and the like of the liquid crystal device 100. Thus, in FIG. 3, the inspection circuit 103 is not illustrated. Note that, in FIG. 1, the data-line driving circuit 101, the scanning-line driving circuit 102, and the inspection circuit 103 are illustrated as peripheral circuits formed on the outer side of the pixel area E. However, it may be provided, as peripheral circuits, a sampling circuit that samples the image signals described above configured to supply the sampled signals to the data line 6a, a pre-charging circuit that is configured to supply a pre-charging signal at a predetermined voltage level to the data line 6a prior to the image signals D1 to Dn described above, or other circuits.

Configuration of Pixel P

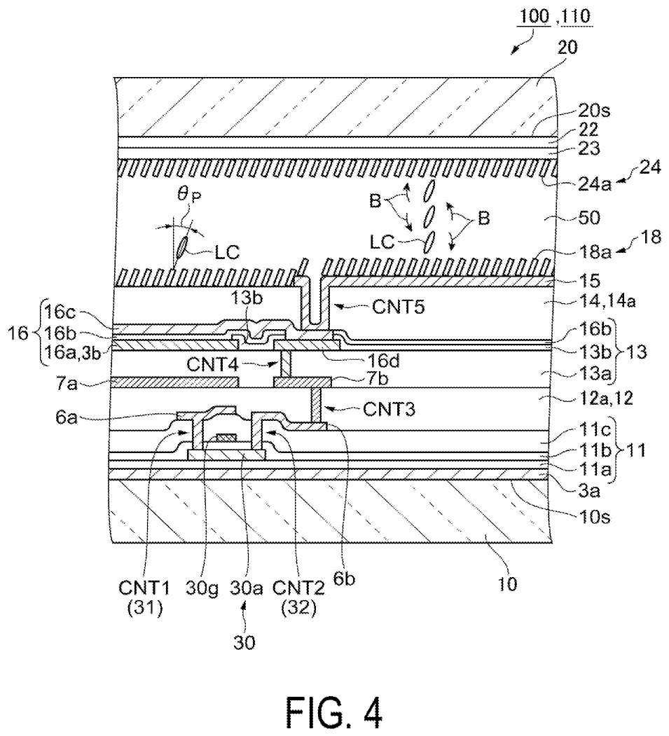

FIG. 4 is a cross-sectional view schematically illustrating the structure of the pixel P illustrated in FIG. 3. As illustrated in FIG. 4, a scanning line 3a is formed on the one-side surface 10s of the first substrate 10. The scanning line 3a includes a light shielding layer made, for example, of aluminum (Al), titanium (Ti), chromium (Cr), tungsten (W), tantalum (Ta), molybdenum (Mo), and the like.

A first insulating film 11a (base insulating film) made of silicon oxide or the like is formed on the upper layer of the scanning line 3a, and a semiconductor layer 30a is formed on the upper layer of the first insulating film 11a. The semiconductor layer 30a is made of a polycrystalline silicon film. The semiconductor layer 30a is covered with a second insulating film (gate insulating film) 11b made of silicon oxide or the like, and a gate electrode 30g is formed on the upper layer of the second insulating film 11b.

A third insulating film 11c made of silicon oxide or the like is formed on the upper layer of the gate electrode 30g. In the second insulating film 11b and the third insulating film 11c, contact holes CNT1 and CNT2 extending to the source area and the drain area of the semiconductor layer 30a are formed. The data line 6a (source electrode) coupled to the semiconductor layer 30a through the contact hole CNT1 and CNT2, and a first relay electrode 6b (drain electrode) are formed on the upper layer of the third insulating film 11c. The TFT 30 is configured in this manner. In the present exemplary embodiment, the TFT 30 has a lightly doped drain (LDD) structure.

A first interlayer insulating film 12a made of silicon oxide or the like is formed on the upper layer side of the data line 6a and the first relay electrode 6b. The surface of the first interlayer insulating film 12a is flattened through a Chemical Mechanical Polishing (CMP) or the like. A contact hole CNT3 extending to the first relay electrode 6b is formed in the first interlayer insulating film 12a. A wiring line 7a and a second relay electrode 7b that is electrically coupled to the first relay electrode 6b through the contact hole CNT3 is formed in the upper layer of the first interlayer insulating film 12a. The wiring line 7a is formed to overlap with the semiconductor layer 30a of the TFT 30 and the data line 6a in plan view, and functions as a shielding layer to which a fixed potential is applied.

A second interlayer insulating film 13a made of silicon oxide or the like is formed on the upper layer side of the wiring line 7a and the second relay electrode 7b. The surface of the second interlayer insulating film 13a is flattened through a CMP process or the like. A contact hole CNT4 extending to the second relay electrode 7b is formed in the second interlayer insulating film 13a.

A first capacitor electrode 16a and a third relay electrode 16d are formed on the upper layer of the second interlayer insulating film 13a using a metal having a light shielding property, or the like. The first capacitor electrode 16a is a capacitor line 3b formed to extend over a plurality of pixels P, and a fixed potential is supplied to this electrode. An insulating film 13b is formed on the upper layer of the first capacitor electrode 16a and the third relay electrode 16d to cover the outer edge of the first capacitor electrode 16a, the outer edge of the third relay electrode 16d, and the like. A dielectric layer 16b is formed on the upper layer side of the first capacitor electrode 16a and the insulating film 13b. The dielectric layer 16b is made of a silicon nitride film, hafnium oxide (HfO₂), alumina (Al₂O₃), tantalum oxide (Ta₂O₅), or the like. A second capacitor electrode 16c made of titanium nitride (TiN) or the like is formed on the upper layer of the dielectric layer 16b. The first capacitor electrode 16a, the dielectric layer 16b, and the second capacitor electrode 16c constitute the storage capacitor 16. The second capacitor electrode 16c is electrically coupled to the third relay electrode 16d through a removal portion of the dielectric layer 16b and the insulating film 13b.

A fourth interlayer insulating film 14a made of silicon oxide or the like is formed on the upper layer side of the second capacitor electrode 16c, and the surface of the fourth interlayer insulating film 14a is flattened through a CMP process or the like. A contact hole CNT5 that reaches the second capacitor electrode 16c is formed in the fourth interlayer insulating film 14a. The pixel electrode 15 made of a light-transmissive conductive film such as ITO is formed on the upper layer of the fourth interlayer insulating film 14a. The pixel electrode 15 is electrically coupled to the second capacitor electrode 16c through the contact hole CNT5.

In the liquid crystal device 100 configured in this manner, a plurality of wiring lines are formed on the one-side surface 10s side of the first substrate 10, and the wiring line portions are referred using reference symbols of an insulating film or an interlayer insulating film that insulates between the wiring lines. In other words, the first insulating film 11a, the second insulating film 11b, and the third insulating film 11c are collectively referred to as a wiring layer 11. A representative wiring line of the wiring layer 11 is a scanning line 3a. A representative wiring line of the wiring layer 12 is a data line 6a. The second interlayer insulating film 13a, the insulating film 13b, and the dielectric layer 16b are collectively referred to as a wiring layer 13. A representative wiring line of the wiring layer 13 is a wiring line 7a. Similarly, a representative wiring line of the wiring layer 14 is a capacitor line 3b serving as the first capacitor electrode 16a.

Configuration of Liquid Crystal Layer 50 and Other Components

The first alignment film 18 and the second alignment film 24 are inorganic alignment films, and are made of a group body of columns 18a and 24a in which an inorganic material such as silicon oxide is deposited diagonally and grown in a columnar shape. Thus, in the liquid crystal layer 50, liquid crystal molecules LC that have a pre-tilt angle θp of 3° to 5° from w the normal direction relative to the first substrate 10 and the second substrate 20 are substantially vertically aligned (VA; Vertical Alignment). When a driving signal is applied across the pixel electrode 15 and the common electrode 23, the inclination of the liquid crystal molecules LC changes according to the electric field direction generated between the pixel electrode 15 and the common electrode 23.

Ionic Impurity Behavior

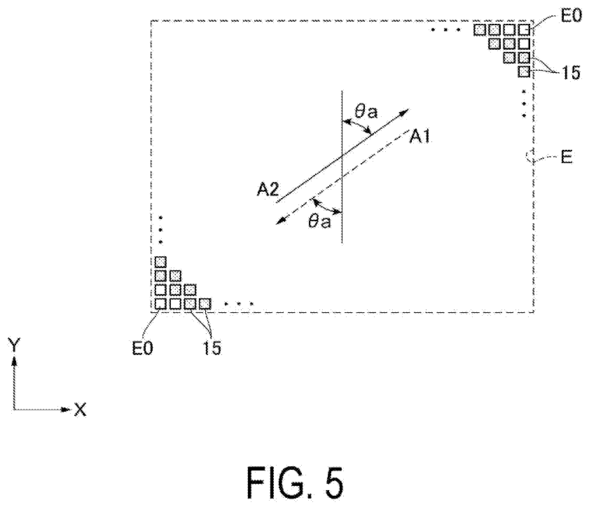

FIG. 5 is an explanatory view schematically illustrating the behavior of ionic impurities in the liquid crystal device 100 illustrated in FIG. 1. FIG. 5 illustrates a state in which the liquid crystal device 100 is viewed from the second substrate 20 side. In FIG. 5, the oblique deposition direction at the time of forming the first alignment film 18 on the first substrate 10 is, for example, an orientation indicated as the dashed arrow A1, and is a direction that forms an angle θa in the Y direction. The oblique deposition direction at the time of forming the second alignment film 24 on the second substrate 20 is, for example, an orientation indicated as the solid arrow A2, and is a direction that forms an angle θa in the Y direction. The angle θa is, for example, 45 degrees. The orientation of oblique deposition at the time of forming the first alignment film 18 on the first substrate 10 and the orientation of oblique deposition at the time of forming the second alignment film 24 on the second substrate 20 are opposite to each other.

In the liquid crystal device 100 configured in this manner, when the liquid crystal layer 50 is driven, the liquid crystal molecules LC vibrate as indicated by the arrow B in FIG. 4, and a flow of the liquid crystal molecules LC occurs in the oblique vapor deposition direction indicated as the dashed line arrow A1 or solid arrow A2 illustrated in FIG. 5. Thus, when ionic impurities are contained in the liquid crystal layer 50, the ionic impurities move toward the corner E0 of the pixel area E along the flow of the liquid crystal molecules LC, and are unevenly distributed. In areas where ionic impurities are unevenly distributed, the insulating resistance of the liquid crystal layer 50 decreases, which leads to a decrease in driving potential. This causes generation of an image persistence phenomenon at the corner E0 due to display unevenness or energization. In particular, in a case where an inorganic alignment film is used for the first alignment film 18 and the second alignment film 24, the inorganic alignment film is more likely to adsorb ionic impurities, and hence, the display unevenness and the image persistence phenomenon are more likely to be generated, as compared with the organic alignment film. For this reason, as described below, the liquid crystal device 100 according to the present exemplary embodiment is configured to include an ion trapping mechanism 130 that prevents the ion impurity from being unevenly distributed.

Description of Ion Trapping Mechanism 130 and Others

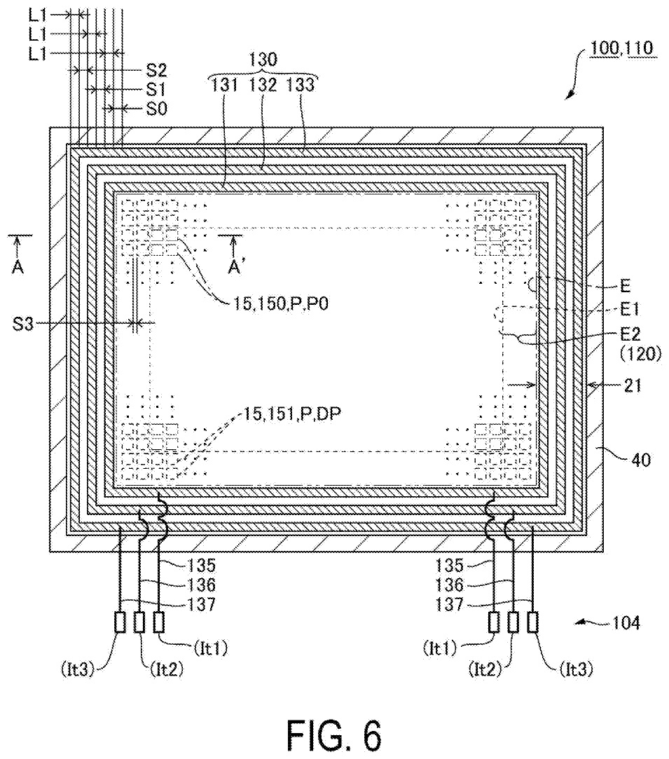

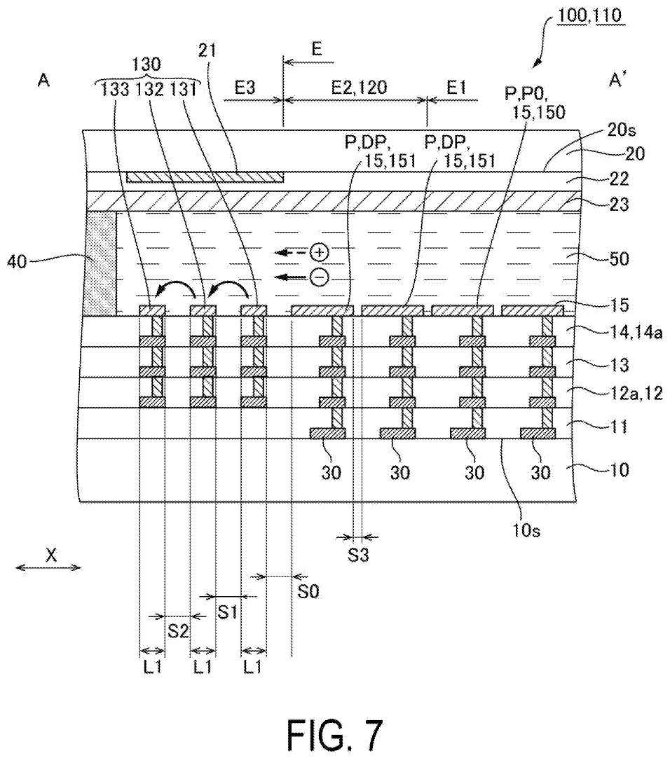

FIG. 6 is an explanatory view illustrating the pixel area E of the liquid crystal device 100 illustrated in FIG. 1. FIG. 7 is a cross-sectional view schematically illustrating a state in which the liquid crystal panel 110 is cut along the line A-A′ in FIG. 6. As illustrated in FIGS. 6 and 7, the pixel area E of the liquid crystal device 100 according to the present exemplary embodiment includes a plurality of pixels P arranged in the X direction and the Y direction. A pixel electrode 15 that is electrically coupled to the TFT 30 is provided for each of the plurality of pixels P. The pixel P and the pixel electrode 15 have the same planar shape, size, placement pitch, and the like.

In the present exemplary embodiment, the pixel area E includes a display area E1 in which display pixels P0 of the plurality of pixels P that directly contribute to display are disposed. The pixel area E also includes a dummy pixel area E2 disposed in the vicinity of the display area E1 and including a plurality of dummy pixels DP of the plurality of pixels P, and these dummy pixels do not directly contribute to display. In the following description, of the plurality of pixel electrodes 15, pixel electrodes 15 provided in a display pixel P0 are referred to as effective pixel electrodes 150, and pixel electrodes 15 provided in a dummy pixel DP are referred to as dummy pixel electrodes 151. In the aspect illustrated in FIG. 6, pairs of two dummy pixels DP are disposed in the dummy pixel area E2 with the display area E1 being disposed between each pair of dummy pixels DP in the X direction, and pairs of two dummy pixels DP are disposed with the display area E1 being disposed between each pair of dummy pixels DP in the Y direction. However, the number of dummy pixels DP disposed in the dummy pixel area E2 is not limited to this, and it is only necessary that at least one dummy pixel DP is disposed on either side of the display area E1 in each of the X direction and the Y direction. In addition, three or more may be used, and the deposited number may differ between in the X direction and in the Y direction.

In the present exemplary embodiment, the dummy pixel area E2 functions as an electronic demarcation portion 120. More specifically, each of the dummy pixel electrodes 151 is electrically coupled to the TFT 30 provided on the bottom layer side, and in a case where the liquid crystal device 100 is in the normally-black mode, an alternating potential is constantly applied to the extent that the transmittance of the dummy pixels DP does not change, regardless of the display state of the pixel P of the display area E1. Thus, the entire area of the electronic demarcation unit 120 is displayed in black. Note that the demarcation portion 21 described with reference to FIGS. 1 and 2 is located between the sealing material 40 and the dummy pixel area E2, and hence the dummy pixel area E2 (electronic demarcation portion 120) together with the demarcation portion 21 functions as a demarcation that does not depend on the ON and OFF of the liquid crystal device 100.

In relation to configuring the ion trap mechanism 130 in the liquid crystal device 100 having the configuration as described above, either one substrate of the first substrate 10 and the second substrate 20 is provided with a first electrode 131 supplied with a first signal Va and disposed in an area located between the pixel area E and the sealing material 40 in plan view, and is also provided with a second electrode 132 supplied with a second signal Vb having a phase differing from the phase of the first signal Va, the second electrode being disposed in an area located between the first electrode 131 and the sealing member 40 in plan view. In addition, the either one substrate described above includes a third electrode 133 disposed in an area located between the second electrode 132 and the sealing material 40 in plan view, the third electrode 133 being supplied with a third signal Vc having a phase differing from the phase of the first signal Va and the second signal Vb. In the present exemplary embodiment, the first electrode 131, the second electrode 132, and the third electrode 133 are each formed in a quadrangular frame shape surrounding the pixel area E in plan view on the side of the first substrate 10.

One ends of a pair of routing wiring lines 135 extending in the Y direction are electrically coupled to near both ends of a portion of the first electrode 131 extending in the X direction, and the other ends of the routing wiring line 135 are electrically coupled to the terminal 104 formed on the first substrate 10. A terminal 104 to which a pair of routing wiring lines 135 are electrically coupled is referred to as a terminal 104 (It1) to differentiate from the other terminals 104. One end of each of a pair of routing wiring lines 136 extending in the Y direction is electrically coupled to near both ends of a portion of the second electrode 132 extending in the X direction, and the other end of the routing wiring line 136 is electrically coupled to the terminal 104 formed on the first substrate 10. A terminal 104 to which a pair of routing wiring lines 136 are electrically coupled is referred to as a terminal 104 (It2) to differentiate from the other terminals 104. One ends of a pair of routing wiring lines 137 extending in the Y direction are electrically coupled to near both ends of a portion of the third electrode 133 extending in the X direction, and the other ends of the routing wiring line 137 are electrically coupled to the terminal 104 formed on the first substrate 10. A terminal 104 to which a pair of routing wiring lines 137 are electrically coupled is referred to as a terminal 104 (It3) to differentiate from the other terminals 104.

In this manner, the first electrode 131, the second electrode 132, and the third electrode 133, the routing wiring lines 135, 136, and 137, and the terminals 104 (It1, It2 and It3) constitute the ion trap mechanism 130. In the ion trapping mechanism 130, the first signal Va is supplied from the terminal 104 (It1) to the first electrode 131, the second signal Vb is supplied from the terminal 104 (It2) to the second electrode 132, and the third signal Vc is supplied from the terminal 104 (It3) to the third electrode 133.

The present exemplary embodiment employs a configuration in which signals are supplied from two terminals 104 (It1, It2 and It3) to prevent the signals supplied to the first electrode 131, the second electrode 132, and the third electrode 133 from varying according to locations of the first electrode 131, the second electrode 132, and the third electrode 133. However, the present disclosure is not limited to this. The number of each terminal 104 (It1, It2 and It3) may be one or more than three. In addition, the first electrode 131, the second electrode 132, and the third electrode 133 are not limited to an aspect of a square electrode that is electrically closed in plan view, and may be a state (open state) in which the one end is coupled to the routing wiring line 135, 136 and 137, and the other end is opened.

Note that, as illustrated in FIG. 7, a plurality of wiring layers 11 to 14 are provided on the one-side surface 10s side of the first substrate 10, and the pixel electrode 15, the first electrode 131, the second electrode 132, and the third electrode 133 are each formed on the upper layer of the fourth interlayer insulating film 14a. In the present exemplary embodiment, the pixel electrode 15, the first electrode 131, the second electrode 132, and the third electrode 133 are formed by patterning the same light-transmissive conductive film (for example, an ITO film) in the process of forming the pixel electrode 15. The routing wiring line 135, 136, and 137 is electrically coupled to the terminals 104 (It1, It2 and It3) with a configuration similar to the wiring layers 11 to 14.

Operation of Ion Trap Mechanism 130

In the ion trapping mechanism 130, the first signal Va is supplied to the first electrode 131, and the second signal Vb having a phase differing from the phase of the first signal Va is supplied to the second electrode 132. In addition, the third signal Vc having a phase differing from the phase of the first signal Va and the second signal Vb is supplied to the third electrode 133. More specifically, the first electrode 131, the second electrode 132, and the third electrode 133 are provided with an alternating signal so that a direction of an electric field (electric line of force) generated across adjacent electrodes moves in a direction from the first electrode 131, which is close to the pixel area E, to the second electrode 132, and then, moves in a direction from the second electrode 132 toward the third electrode 133. The alternating signal is a signal that undergoes transition to high potentials and low potentials with the common potential (LCCOM) provided to the common electrode 23 being as the reference potential. Ionic impurities having the positive polarity (+) or negative polarity (−) are swept from the dummy pixel area E2 to the demarcation area E3 in association with the movement of direction of electric field from the first electrode 131 to the third electrode 133.

Such operations may be performed for either a period of time in which the image is displayed or a period of time during which the image is ceased to be displayed.

Method for Driving Liquid Crystal Apparatus 100

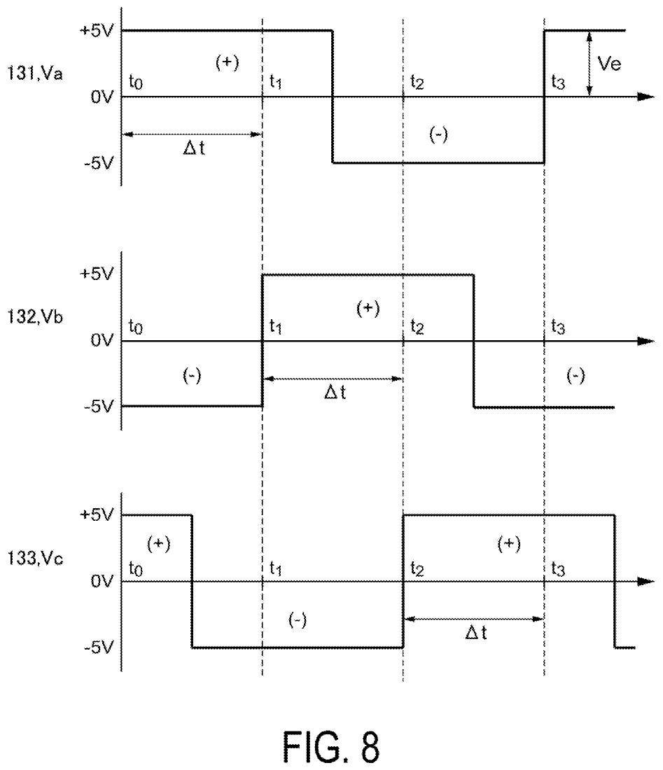

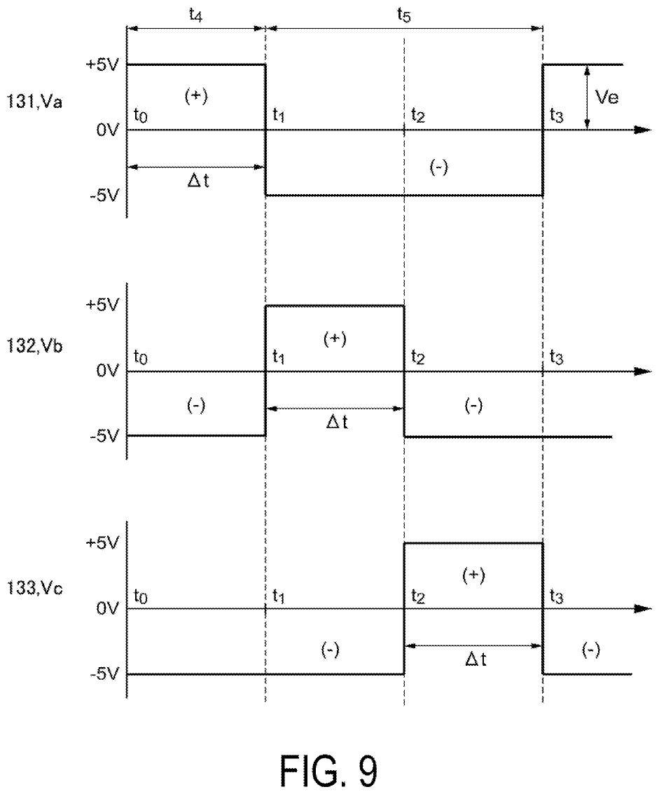

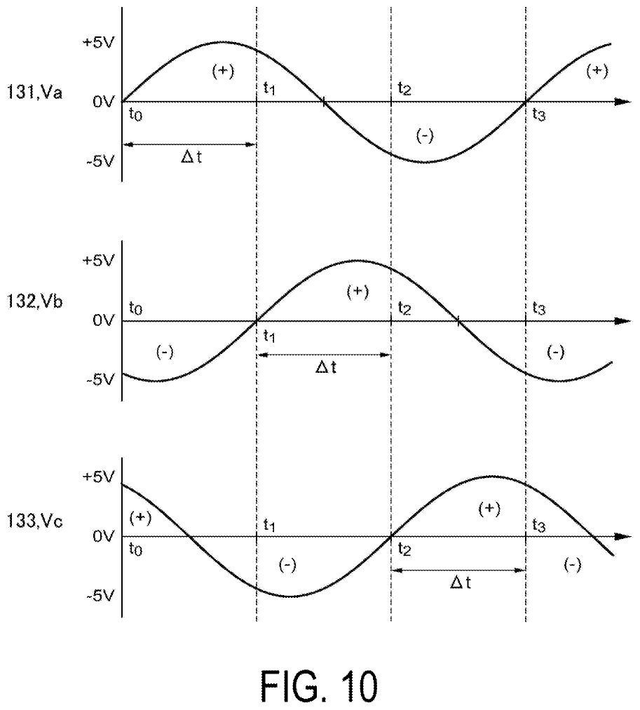

FIG. 8 is an explanatory view illustrating a first example of signals used in the ion trapping mechanism 130 illustrated in FIG. 7. FIG. 9 is an explanatory view illustrating a second example of signals used in the ion trapping mechanism 130 illustrated in FIG. 7. FIG. 10 is an explanatory view illustrating a third example of signals used in the ion trap mechanism 130 illustrated in FIG. 7.

In the liquid crystal device 100 according to the present exemplary embodiment, alternating signals having rectangular wave are applied to each of the first electrode 131, the second electrode 132, and the third electrode 133, as illustrated, for example, in FIG. 8. Specifically, alternating signals (first signal Va, second signal Vb and third signal Vc) having the same frequency and different phases are supplied to each of the first electrode 131, the second electrode 132, and the third electrode 133. More specifically, after the first signal Va supplied to the first electrode 131 undergoes transition from the positive polarity (+) or the reference potential to the negative polarity (−) and before the first signal undergoes transition to the reference potential or the positive polarity (+), the second signal Vb supplied to the second electrode 132 undergoes transition from the positive polarity (+) or the reference potential to the negative polarity (−). Furthermore, after the second signal Vb undergoes transition to the negative polarity (−) and before the second signal undergoes transition to the reference potential or the positive polarity (+), the third signal Vc applied to the third electrode 133 undergoes transition from the positive polarity (+) or the reference potential to the negative polarity (−). In addition, after the first signal Va applied to the first electrode 131 undergoes transition from the negative polarity (−) or the reference potential to the positive polarity (+) and before the first signal undergoes transition to the reference potential or the negative polarity (−), the second signal Vb applied to the second electrode 132 undergoes transition from the negative polarity (−) or the reference potential to the positive polarity (+). Moreover, after the second signal Vb undergoes transition from the negative polarity (−) or the reference potential to the positive polarity (+) and before the second signal undergoes transition to the reference potential or the negative polarity (−), the third signal Vc applied to the third electrode 133 undergoes transition from the negative polarity (−) or the reference potential to the positive polarity (+).

Here, with respect to the alternating signal (first signal Va) provided to the first electrode 131, the alternating signal (second signal Vb) provided to the second electrode 132 is delayed by a Δt time in the time axis t. Similarly, with respect to the alternating signal (second signal Vb) provided to the second electrode 132, the alternating signal (third signal Vc) provided to the third electrode 133 is delayed by a Δt time in the time axis t. For example, assuming that the Δt time is ⅓ periods, the alternating signals provided to each of the first electrode 131, the second electrode 132, and the third electrode 133 are shifted in phase by ⅓ periods with each other. In other words, the maximum amount of phase shift Δt in which the potentials of the first electrode 131, the second electrode 132, and the third electrode 133 are shifted in phase with each other is a value obtained by dividing one cycle of the alternating signal by the number of electrodes n.

Note that the alternating signal having the square wave illustrated in FIG. 8 makes transition to a high potential (5 V) and a low potential (−5 V) with the reference potential being set as 0 V. However, the setting of the reference potential, high potential, and low potential is not limited to this.

In the case of the ion trapping mechanism 130 described above, from the time t0 to the time t1 illustrated in FIG. 8, the second signal Vb supplied to the second electrode 132 adjacent to the first electrode 131 has a negative polarity of −5 V when the first signal Va supplied to the first electrode 131 is at a positive polarity (+) of 5 V. Thus, an electric field (electric line of force indicated by the solid line) running from the first electrode 131 toward the second electrode 132 is generated between the first electrode 131 and the second electrode 132, as illustrated in FIG. 7.

In addition, when the second signal Vb supplied to the second electrode 132 has the positive polarity (+) of 5 V in a period from the time t1 to the time t2, the third potential supplied to the third electrode 133 adjacent to the second electrode 132 has the negative polarity (−) of −5 V. Thus, as illustrated in FIG. 7, an electric field running from the second electrode 132 toward the third electrode 133 is generated between the second electrode 132 and the third electrode 133.

Furthermore, when the third signal Vc supplied to the third electrode 133 has the positive polarity (+) of 5 V in a period from the time t2 to the time t3, the second signal Vb supplied to the second electrode 132 adjacent to the third electrode 133 makes transition from the positive polarity (+) of 5 V to the negative polarity (−) of −5. Thus, in a period of time corresponding to one period of the alternating signal from the time t0 to the time t3, the distribution of the electric field between the electrodes of the first electrode 131, the second electrode 132, and the third electrode 133 is scrolled in terms of time from the first electrode 131 to the third electrode 133. The way in which the electric field is generated using such alternating signals is referred to as a “scroll of the electric field”.

Here, an ionic impurity having a positive polarity (+) may exist and an ionic impurity having a negative polarity (−) may exist. The ionic impurities of the positive polarity (+) or the negative polarity (−) are drawn to the first electrode 131 in response to the polarity of the first potential of the first electrode 131. When the ionic impurities that has been drawn to the first electrode 131 are left there as they are, the ionic impurities gradually accumulate and may affect the electronic demarcation 120 and the display of the display area E1. Thus, the ionic impurities that have been drawn to the first electrode 131 are sequentially moved to the second electrode 132 or the third electrode 133.

In the case of the present exemplary embodiment, alternating signals that are shifted in phase with each other are applied to the first electrode 131, the second electrode 132, and the third electrode 133 to scroll the distribution of the electric field generated between the electrodes, from the first electrode 131 via the second electrode 132 to the third electrode 133, as described above. This enables ionic impurities having a positive polarity (+) or negative polarity (−) drawn to the first electrode 131, to be transferred via the second electrode 132 to the third electrode 133. Thus, each of the first electrode 131, the second electrode 132, and the third electrode 133 are ion trap electrodes.

Furthermore, to ensure that the ionic impurity is swept to the third electrode 133 in association with the scrolling of the electric field, the frequency of the alternating signal needs to be determined by taking into account the movement velocity of the ionic impurity. When the velocity of the scroll of the electric field is faster than the movement speed of the ionic impurity, the ionic impurity may not follow the scroll of the electric field, which may lead to a reduction in the effect of sweeping the ionic impurities.

The inventors have derived the preferred frequency f (Hz) of an AC signal in the ion trapping mechanism 130 as follows. First, the movement velocity v (m/s) of ionic impurities in the liquid crystal layer is given by the product of the electric field intensity e (V/m) of adjacent ion trap electrodes (the first electrode 131, the second electrode 132, and the third electrode 133), and the mobility μ (m²/V·s) of the ionic impurities, as represented in Expression (1).

v=e·μ (1)

The electric field intensity e (V/m) is a value obtained by dividing the potential difference Vn between the adjacent ion trap electrodes by the placement pitch p (m) of the ion trap electrode, as represented by Expression (2).

e=Vn/p (2)

The potential difference Vn between adjacent ion trap electrodes corresponds to twice the effective voltage VE in the AC signal, and thus, the following Expression (3) is derived.

e=2VE/p (3)

As illustrated in FIG. 7, the effective voltage VE in the AC signal of a rectangular wave corresponds to the electric potential with respect to the reference potential of the rectangular wave, and is 5 V in the present exemplary embodiment.

Expression (3) is applied to Expression (1) to form Expression (4) indicating the movement velocity v (m/s) of the ionic impurities.

v=2μVE/p (4)

Thus, the time td during which ionic impurities move between adjacent ion trap electrodes is a value obtained by dividing the placement pitch p of the adjacent ion trap electrodes by the movement velocity v of the ionic impurities, as represented in Expression (5).

td=p/v=p2/2μVE (5)

Accordingly, the preferred frequency f (Hz) is determined by scrolling the electric field in accordance with the time td during which the ionic impurities move between adjacent ion trap electrodes. The scroll time of the electric field corresponds to the phase difference Δt of the AC signal, so that the preferred frequency f (Hz) is derived by the following Expression (6), where Δt is indicated as 1/n period as described above. The number of ion trap electrodes is indicated as n.

f=1/n/td=2μVE/np² (6)

As described above, when the phase difference Δt of the AC signal applied to the adjacent ion trap electrodes is indicated as ⅓ period, the potential difference Vn between the adjacent ion trapping electrodes in the ion trapping mechanism 130 is 10 V in the case of an AC signal of a rectangular wave that undergoes transition between 5 V and −5 V with a reference potential of 0 V. When the placement pitch p of the ion trap electrodes in the ion trapping mechanism 130 is 8 μm and the mobility μ of the ionic impurities is 2.2×10⁻¹⁰ (m²/V·s), the preferred frequency f is approximately 12 Hz according to Expression (6). The mobility μ of the ionic impurities has a value that is described in “A Comparative Study on the Attributes of Ions in Nematic and Isotropic Phases”, A. Sawada, A. Manabe and S. Naemura, JPn. J. Appl Phys Vol. 40, p 220 to p 224 (2001), for example.

The AC signal at a frequency of more than 12 Hz causes ionic impurities not to follow scrolling of the electric field, so that the frequency f is preferably equal to or less than 12 Hz. In addition, a frequency f that is too small is unfavorable because it causes direct current to be applied between the ion trap electrodes to result in degradation of liquid crystal, display defects such as image sticking and spots occur, and the like.

The AC signal to be applied to the ion trap electrode is not limited to the AC signal of a rectangular wave illustrated in FIG. 8. For example, it may be a rectangular wave as illustrated in FIG. 9. While the AC signal of the rectangular wave in FIG. 8 has potential with positive polarity (+) and potential with negative polarity (−) at the same interval of time, the AC signal may be set such that a time t5 having potential with negative polarity (−) is longer than a time t4 having potential with positive polarity (+), as illustrated in FIG. 9, for example. According to the manufacturing process of the liquid crystal device 100, ionic impurities with positive polarity (+) and negative polarity (−) may be contained in the liquid crystal layer 50, and it is known that the ionic impurities with positive polarity (+) cause display quality to be lower than the ionic impurities with negative polarity (−). Thus, when an AC signal with a setting with a long time t5 having negative (−) electric potential is applied to each of the ion trap electrodes, ionic impurities with positive polarity (+) can be effectively swept.

While the AC signal of the rectangular wave may be oscillated between two potentials of 5 V and −5 V with the reference potential of 0 V, as illustrated in FIGS. 8 and 9, for example, a waveform may be set so as to undergo transition among potentials of three or more different values. This enables ionic impurities to be smoothly moved from the first electrode 131 to the third electrode 133 via the second electrode 132 in the ion trapping mechanism 130. In addition to the AC signal of the rectangular wave illustrated in FIGS. 8 and 9, an AC signal of a triangular wave can also be employed.

In the aspect illustrated in FIG. 10, the AC signal applied to each of the ion trap electrodes is a sine wave having phases different from each other within a period of time. However, compared to an analog circuit that produces an analog signal such as a sine wave, a digital circuit that produces a rectangular wave can be simplified in circuit configuration.

When AC signals each have the same frequency, the AC signals to be applied to the first electrode 131, the second electrode 132, and the third electrode 133, are each not necessarily required to have an amplitude with the same magnitude, i.e., the same maximum potential with positive polarity with respect to the reference potential, and the same maximum potential with negative polarity with respect thereto. For example, as described above, the first electrode 131 is provided with an AC signal that oscillates between 5 V and −5 V, with the reference potential of 0 V. In contrast, the second electrode 132 is provided with an AC signal that oscillates between 7.5 V and −7.5 V with the reference potential of 0 V, and the third electrode 133 is provided with an AC signal that oscillates between the 10 V and the −10 V with the reference potential of 0 V. When the AC signal to be applied to each of the three ion trap electrodes is increased in magnitude of the amplitude with interval from a pixel region E, ionic impurities can be effectively swept.

Frequency f of AC Signal

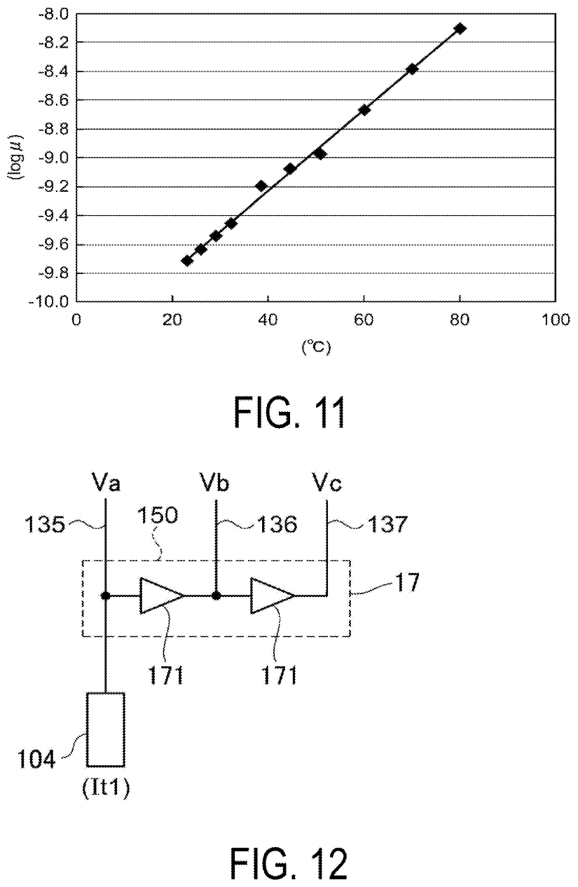

FIG. 11 is a graph showing a relationship between mobility and temperature of ionic impurities in the liquid crystal layer. The graph shown in FIG. 11 is obtained with reference to values of the mobility μ of the ionic impurities described in the aforementioned document.

Driving the pixels P causes a flow of the liquid crystal molecule LC in the liquid crystal layer 50 as described above, so that this flow moves the ionic impurities in the pixel region E. It is conceivable that velocity of the flow depends on the frequency of a drive signal driving the pixels P. To reliably attract ionic impurities being moved by this flow from the pixel region E to the ion trap electrodes (the first electrode 131, the second electrode 132, and the third electrode 133), it is preferable to cause the movement of the electric field generated between the ion trap electrodes to be slow. In other words, it is preferable that the frequency f (Hz) of the AC signal applied to the ion trap electrode is smaller than the frequency of the drive signal driving the pixels P.

Meanwhile, the mobility μ (the movement velocity v) of the ionic impurities depends on temperature. Thus, when the liquid crystal device 100 is actually driven at temperature higher than room temperature, even a frequency f set to more than 12 Hz enables effect of sweeping the ionic impurities to be obtained.

As shown in FIG. 11, the mobility μ of the ionic impurities has a value of approximately 2.2×10⁻¹⁰ (m²/V·s) at a temperature of 25° C., and a value of log μ is −9.6. In contrast, the mobility μ of the ionic impurities has a value of approximately 2.2×10⁻⁹ (m²/V·s) at a temperature of 60° C., and a value of log μ is −8.7. That is, the mobility μ of the ionic impurities at 60° C. is approximately 10 times of that at 25° C. Focusing on the temperature of 60° C. is due to the consideration of temperature at which the liquid crystal device 100 is used as a light bulb of a projection-type display device described below.

According to Expression (6) above, where n is 3, VE is 5 V, p is 8 μm, and μ at a temperature of 60° C. is 2.2×10⁻⁹ (m²/V·s), the optimal frequency f is approximately 113 Hz. In this state, it is conceivable that while the optimal frequency f of the AC signal applied to the ion trap electrode is more than 60 Hz of the driving frequency of the present exemplary embodiment, effect of sweeping ionic impurities can be obtained. In other words, it is conceivable that a driving frequency of 120 Hz, for example, which is more than the optimal frequency f of the AC signal, enables ionic impurities to be more effectively swept.

Supply AC Signal

FIG. 12 is a circuit diagram illustrating a configuration for generating the signal illustrated in FIG. 8 and the like. As illustrated in FIG. 6, while AC signals each having the same frequency and a different phase are applied to the first electrode 131, the second electrode 132, and the third electrode 133, in the ion trapping mechanism 130, via the corresponding three external terminals 104 (It1, It2 and It3) in the above exemplary embodiment, the first electrode 131, a method (means) for applying AC signals each having the same frequency and a different phase is not limited thereto.

For example, as illustrated in FIG. 12, the liquid crystal device 100 may include a delay circuit 17 having a delay element 171 provided between the lead wire 135 and the lead wire 136, and a delay element 171 provided between the lead wire 136 and the lead wire 137. The delay element 171 may have a circuit configuration including a capacitive element (C) and an inductor element (L), or a circuit configuration including a resistor (R) and the capacitive element (C), for example. According to the delay circuit 17 as described above, when the first signal Va is supplied to the terminal 104 (It1), a first AC signal is applied to the first electrode 131 via the lead wire 135. When the first signal Va is transmitted to the lead wire 136 via the delay element 171, a second signal Vb shifted in phase from the first signal Va is applied to the second electrode 132 via the lead wire 136. When the second signal Vb is transmitted to the lead wire 137 via the delay element 171, a third signal Vc shifted in phase from the second signal Vb is applied to the third electrode 133 via the lead wire 137. The aspect described above allows only the first signal Va to be generated in an external circuit and supplied to the terminal 104 (It1), so that the circuit configuration of the entire device can be simplified.

Detailed Configuration of Ion Trap Electrode

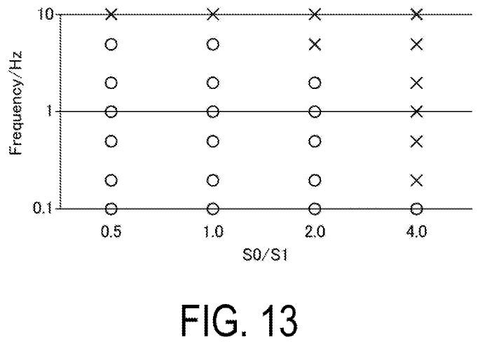

FIG. 13 is an explanatory diagram illustrating a relationship between the configuration of the ion trap electrode illustrated in FIG. 6 and effect of sweeping ionic impurities, and FIG. 13 shows a ratio of distances between respective electrodes and the effect of sweeping ionic impurities when the signal is changed in frequency. FIG. 13 shows results of evaluation of the effect of sweeping ionic impurities with an electrophoretic simulator when a value acquired by dividing an interval S0 between the first electrode 131 and the pixel electrode 15 by an interval S1 between the first electrode 131 and the second electrode 132 is changed from 0.5 to 4, and signal frequency is changed from 0.1 Hz to 10 Hz. In FIG. 13, a condition allowing a sufficient effect of sweeping ionic impurities to be obtained is indicated by “∘”, and a condition allowing an insufficient effect of sweeping ionic impurities to be obtained is indicated by “x”. The ion trap electrodes (the first electrode 131, the second electrode 132, and the third electrode 133) have a placement pitch of 4 μm. The ion trap electrodes each have a width of 2 μm, and an interval between the corresponding ion trap electrodes is 2 μm.

As illustrated in FIGS. 6 and 7, the first electrode 131, the second electrode 132, and the third electrode 133 are disposed at equal intervals in X-direction, in the present exemplary embodiment. While not illustrated in the drawings, the first electrode 131, the second electrode 132, and the third electrode 133 are disposed at equal intervals also in Y-direction. The first electrode 131, the second electrode 132, and the third electrode 133 each have a width L1 of 4 μm in X-direction, for example, and a pitch in X-direction in a plan view between the corresponding first electrode 131, second electrode 132, and third electrode 133, is 8 μm, for example. Thus, the interval S1 (second interval) in X-direction in plan view between the first electrode 131 and the second electrode 132, and the interval S2 (third interval) in X-direction in a plan view between the second electrode 132 and the third electrode 133, are each 4 μm. The first electrode 131, the second electrode 132, and the third electrode 133 each have a width of 4 μm in Y-direction, for example, and a pitch in Y-direction in plan view between the corresponding first electrode 131, second electrode 132, and third electrode 133 is 8 μm, for example. Thus, an interval in Y-direction (second interval) in plan view between the first electrode 131 and the second electrode 132, and an interval in Y-direction (third interval) in plan view between the second electrode 132 and the third electrode 133, are each 4 μm.

When the placement pitch of the ion trap electrodes (the first electrode 131, the second electrode 132 and the third electrode 133) is reduced to less than 8 μm, the preferred frequency f can be increased. In addition, when the number of ion trap electrodes is further increased from three, the ionic impurities can be swept farther from the pixel region E.

As illustrated in FIG. 13, when signal frequency is changed from 0.1 Hz to 10 Hz and a value acquired by dividing the interval S0 (first interval) between the first electrode 131 and the pixel electrode 15 by the interval S1 between the first electrode 131 and the second electrode 132 (equal to the interval S2 between the second electrode 132 and the third electrode 133) is changed from 0.5 to 4, a smaller ratio (S0/S1) increases an upper limit of the frequency allowing a sufficient effect of sweeping to be obtained. For example, when the ratio (S0/S1) is 0.5 to 1.0, a sufficient effect of sweeping can be obtained with a signal frequency of 0.1 Hz to 5 Hz, whereas when the ratio (S0/S1) is 2.0, a sufficient effect of sweeping can be obtained with only a signal frequency of 0.1 Hz to 2 Hz, and when the ratio (S0/S1) is 4.0, a sufficient effect of sweeping can be obtained with only a signal frequency of 0.1 Hz. Thus, a ratio (S0/S1) of 1 or less enables a sufficient effect of sweeping to be obtained even at a relatively high frequency.

Thus, in the present exemplary embodiment, the interval S0 between the pixel electrode 15 adjacent to the first electrode 131 in X-direction, and the first electrode 131, in X-direction in plan view, among the plurality of pixel electrodes 15 is set to be equal to or less than the interval S1 between the first electrode 131 and the second electrode 132 in X-direction in plan view (equal to the interval S2 between the second electrode 132 and the third electrode 133 in X-direction in plan view). In addition, the interval between the pixel electrode 15 adjacent to the first electrode 131 in Y-direction, and the first electrode 131, in Y-direction in plan view, among the plurality of pixel electrodes 15 is set to be equal to or less than the interval S1 between the first electrode 131 and the second electrode 132 in Y-direction in plan view (equal to the interval S2 between the second electrode 132 and the third electrode 133 in Y-direction in plan view).

In the present exemplary embodiment, the interval S0 between the pixel electrode 15 and the first electrode 131 in X-direction in plan view is equal to the interval S1 between the first electrode 131 and the second electrode 132 in X-direction in plan view (equal to the interval S2 between the second electrode 132 and the third electrode 133 in X-direction in plan view). In addition, an interval between the pixel electrode 15 and the first electrode 131 in Y-direction in plan view is equal to an interval between the first electrode 131 and the second electrode 132 in Y-direction in plan view (equal to an interval between the second electrode 132 and the third electrode 133 in Y-direction in plan view). Here, equal intervals mean that design values thereof are equal, and a difference of ±10% in intervals is included in the definition of equal intervals in consideration of variations in a process.

In the present exemplary embodiment, the interval S1 between the first electrode 131 and the second electrode 132 in X-direction in plan view, as well as the interval S2 between the second electrode 132 and the third electrode 133 in X-direction in plan view, is wider than an interval S3 between the pixel electrodes 15 adjacent to each other in X-direction. Accordingly, the interval S0 between the pixel electrode 15 and the first electrode 131 in X-direction in plan view is wider than the interval S3 between the pixel electrodes 15 adjacent to each other in X-direction. In addition, the interval between the first electrode 131 and the second electrode 132 in Y-direction in plan view, as well as the interval between the second electrode 132 and the third electrode 133 in Y-direction in plan view, is wider than an interval between the pixel electrodes 15 adjacent to each other in Y-direction. Accordingly, the interval between the pixel electrode 15 and the first electrode 131 in Y-direction in plan view is wider than the interval between the pixel electrodes 15 adjacent to each other in Y-direction.

For example, in both X-direction and Y-direction, the interval S0 (first interval) between the first electrode 131 and the pixel electrode 15 is 1 μm, as well as the interval S1 between the first electrode 131 and the second electrode 132, and the interval S2 between the second electrode 132 and the third electrode 133, are each also 1 μm. In both X-direction and Y-direction, the interval between the pixel electrodes 15 adjacent to each other is 0.6 μm. The first signal Va, the second signal Vb, and the third signal Vc each have a frequency of 1 Hz, and are shifted from each other in phase by 120. The voltage corresponding to ½ times the maximum voltage amplitude of each of the first signal Va, the second signal Vb, and the third signal Vc is equal to or less than the maximum voltage applied between the pixel electrode 15 and the common electrode 23. For example, the maximum voltage amplitude of each of the first signal Va, the second signal Vb, and the third signal Vc is 10 V, the maximum voltage applied between the pixel electrode 15 and the common electrode 23 is 5 V, and the voltage corresponding to ½ times the maximum voltage amplitude of each of the first signal Va, the second signal Vb, and the third signal Vc is equal to the maximum voltage applied between the pixel electrode 15 and the common electrode 23.

Main Effect of the Present Exemplary Embodiment

As described above, in the liquid crystal device 100 of the present exemplary embodiment, the ion trapping mechanism 130 including the first electrode 131, the second electrode 132, and the third electrode 133 is provided between the pixel region E and the sealing material 40, and each of AC signals shifted from each other in phase is applied to the corresponding one of the first electrode 131, the second electrode 132, and the third electrode 133. For example, each of the first electrode 131, the second electrode 132, and the third electrode 133, receives the corresponding one of AC signals each having the same frequency, and are shifted from each other in phase within a time corresponding to one period. As a result, distribution of electric fields generated among the first electrode 131, the second electrode 132, and the third electrode 133 is scrolled from the first electrode 131 to the third electrode 133, and ionic impurities in the liquid crystal layer 50 are swept from the pixel region E to the outer demarcation region E3 by scrolling the electric fields.

The interval S0 between the first electrode 131 and the pixel electrode 15 is equal to or less than not only the interval S1 between the first electrode 131 and the second electrode 132, but also the interval S2 between the second electrode 132 and the third electrode 133. More specifically, the interval S0 between the first electrode 131 and the pixel electrode 15 is equal to not only the interval S1 between the first electrode 131 and the second electrode 132, but also the interval S2 between the second electrode 132 and the third electrode 133. This enables even ionic impurities with low mobility to be drawn from the pixel region E to the first electrode 131. As a result, the ionic impurities can be appropriately swept out from the pixel region E, so that the ionic impurities are less likely to deteriorate quality of display. In addition, ionic impurities with low mobility can be swept from the pixel region E toward the first electrode 131 without excessively reducing frequency of a signal to be applied to each of the first electrode 131 and the second electrode 132, so that an electrode reaction such electrolysis is less likely to occur.

In addition, in the present exemplary embodiment, the interval S0 between the first electrode 131 and the pixel electrode 15 is equal to or less than not only the interval S1 between the first electrode 131 and the second electrode 132, but also the interval S2 between the second electrode 132 and the third electrode 133, while the voltage corresponding to ½ of the maximum voltage amplitude of each of the first signal Va, the second signal Vb, and the third signal Vc is equal to or less than the maximum voltage applied between the pixel electrode 15 and the common electrode 23. This reduces alignment failure of liquid crystal molecules generated by the voltage applied between the first electrode 131 and the pixel electrode 15. Thus, even a configuration in which the interval S0 between the first electrode 131 and the pixel electrode 15 is reduced to efficiently sweep ionic impurities, causes a problem of leakage of light at the outer peripheral portion of the pixel region E to be less likely to occur. In particular, when the voltage corresponding to ½ times the maximum voltage amplitude of each of the first signal Va, the second signal Vb, and the third signal Vc is equal to the maximum voltage applied between the pixel electrode 15 and the common electrode 23, the ionic impurities can be more reliably swept by reducing the interval S0 between the first electrode 131 and the pixel electrode 15. Even in this case, a problem of leakage of light at the outer peripheral portion of the pixel region E is less likely to occur.

### Second Exemplary Embodiment

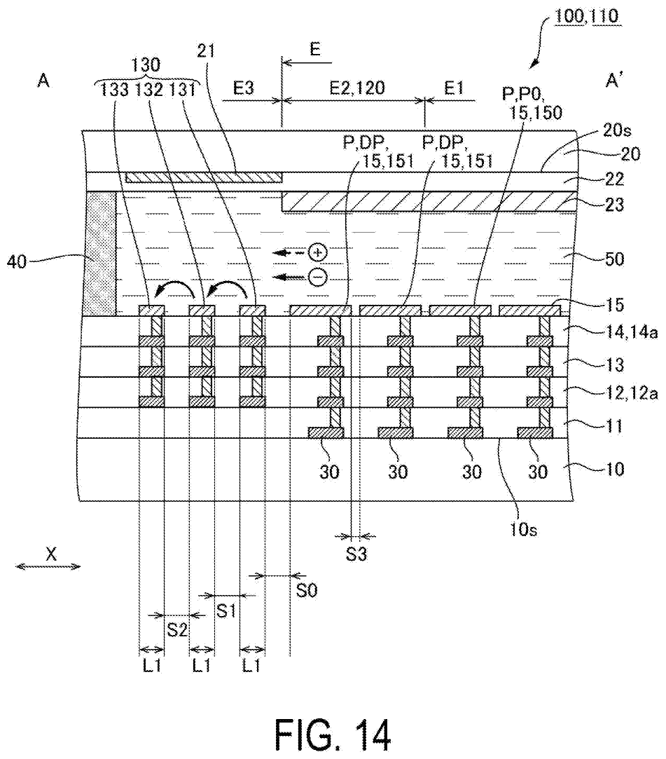

FIG. 14 is an explanatory diagram of the liquid crystal device 100 according to Second Exemplary Embodiment of the present disclosure, and is an explanatory diagram schematically illustrating a configuration of an electrode or the like for an ion trap formed outside a pixel region E. Thus, FIG. 14 corresponds to FIG. 7 referred in First Exemplary Embodiment. Basic configurations of the present exemplary embodiment and embodiments to be described later are each the same as the configuration of First Exemplary Embodiment, and thus a common portion is designated by the same reference signs and description of the common portion will be eliminated.

As illustrated in FIG. 14, while in the present exemplary embodiment, a common electrode 23 provided on a second substrate 20 is provided flat throughout a region overlapping with the pixel region E in plan view, the outer edge of the common electrode 23 is positioned between the pixel region E and a first electrode 131 in plan view. Thus, almost no common electrode 23 is provided in the portion overlapping with ion trap electrodes (a first electrode 131, a second electrode 132, and a third electrode 133) in plan view. This causes an electric field to be less likely to be generated between the ion trap electrodes (the first electrode 131, the second electrode 132, and the third electrode 133) and the common electrode 23, so that ionic impurities can be efficiently swept outside the pixel region E (demarcation region E3) by scrolling electric fields generated among the first electrode 131, the second electrode 132, and the third electrode 133.

In this case, when a drawing wire (not illustrated) extending from a part of the outer edge of the common electrode 23 is provided to electrically couple the common electrode 23 to a vertical conduction portion 106 via the drawing wire, for example, an area of the ion trap electrodes (the first electrode 131, the second electrode 132, and the third electrode 133) and the common electrode 23, overlapping with each other in plan view, can be extremely reduced.

In addition, a partially-cut portion may be provided in each of the first electrode 131, the second electrode 132, and the third electrode 133, and the drawing wire may be extended in a portion overlapping with the partially-cut portion in plan view.

In addition, the common electrode 23 may include an insulating film with an appropriate thickness in an upper layer of a portion thereof formed in a region where each of the first electrode 131, the second electrode 132, and the third electrode 133 is provided, thereby causing an electric field to be less likely to be generated between the ion trap electrodes (the first electrode 131, the second electrode 132, and the third electrode 133) and the common electrode 23.

### Third Exemplary Embodiment

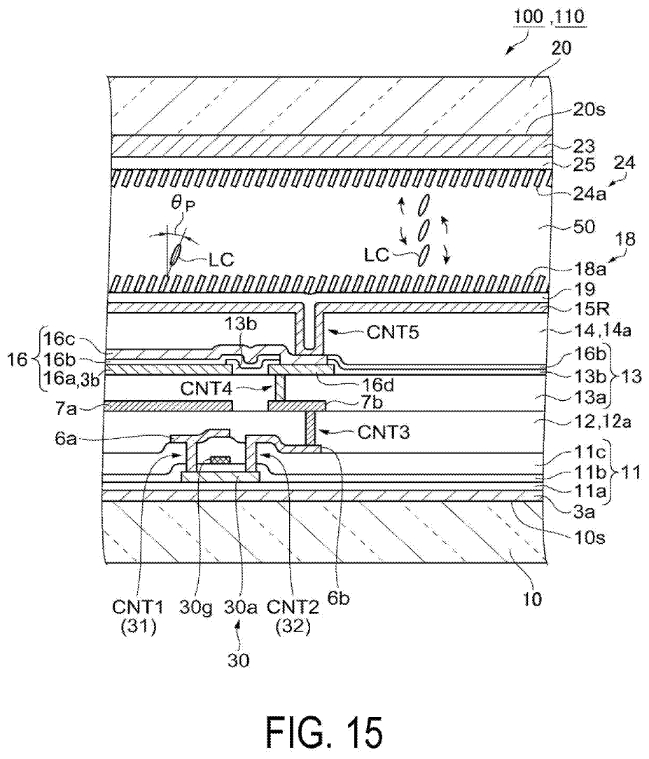

FIG. 15 is an explanatory view of a liquid crystal device 100 according to Third Exemplary Embodiment of the present disclosure. Thus, FIG. 15 corresponds to FIG. 4 referred in First Exemplary Embodiment. While the liquid crystal device 100 according to First Exemplary Embodiment is a transmissive type, the liquid crystal device 100 of the present exemplary embodiment is a reflective type. Thus, a pixel electrode 15 is made of Al (aluminum) having light reflectability, an alloy containing Al, or the like, for example. Here, an inorganic insulating film 19 is formed so as to cover the pixel electrode 15, and a first alignment film 18 is formed in an upper layer of the inorganic insulating film 19.

In a second substrate 20, an inorganic insulating film 25 is formed so as to cover a common electrode 23, and a second alignment film 24 is formed in an upper layer of the inorganic insulating film 25. The inorganic insulating films 19 and 25 are each made of silicon oxide, for example.

According the configuration described above, a problem such as variations (shifting) of the common potential (LCCOM) due to difference in work function is less likely to occur, unlike the case without the inorganic insulating films 19 and 25. As with the pixel electrode 15, a first electrode 131, a second electrode 132, and a third electrode 133 are also covered with the inorganic insulating film 19. Even in this case, an AC signal is applied to each of the first electrode 131, the second electrode 132, and the third electrode 133, so that reduction in potential due to presence of the inorganic insulating film 19 is less likely to occur compared to when DC potential is applied. This enables achieving the reflective liquid crystal device 100 capable of reliably sweeping ionic impurities from a pixel region E to a demarcation region E3.

### Fourth Exemplary Embodiment

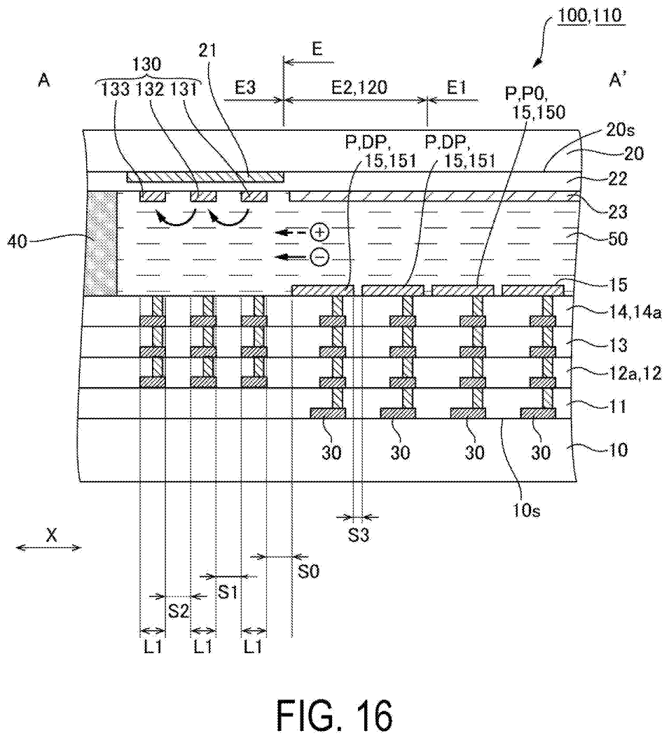

FIG. 16 is an explanatory view of a liquid crystal device 100 according to Fourth Exemplary Embodiment of the present disclosure, and a sectional view schematically illustrating structure of the pixels P. Thus, FIG. 16 corresponds to FIG. 4 referred in First Exemplary Embodiment. While the ion trap electrodes (the first electrode 131, the second electrode 132, and the third electrode 133) are provided on the first substrate 10 in First Exemplary Embodiment, ion trap electrodes (a first electrode 131, a second electrode 132, and a third electrode 133) are provided on a second substrate 20 in the present exemplary embodiment. Here, as with a common electrode 23, the first electrode 131, the second electrode 132, and the third electrode 133 are formed in an upper layer of a flattened film 22. Thus, while not illustrated in the drawings, the first electrode 131, the second electrode 132, and the third electrode 133 are covered with a second alignment film 24. In addition, while the common electrode 23 is provided in the entire region overlapping with a pixel region E in plan view, the outer edge of the common electrode 23 is positioned between the pixel region E and the first electrode 131 in plan view.

In the configuration described above, a drawing wire (not illustrated) extending from a part of the outer edge of the common electrode 23 is provided to electrically couple the common electrode 23 to a vertical conduction portion 106 via a drawing wire. In addition, a drawing wire (not illustrated) is also provided to the first electrode 131, the second electrode 132, and the third electrode 133 to electrically couple each of the first electrode 131, the second electrode 132, and the third electrode 133 to a vertical conduction portion separate from the vertical conduction portion 106.

### Fifth Exemplary Embodiment

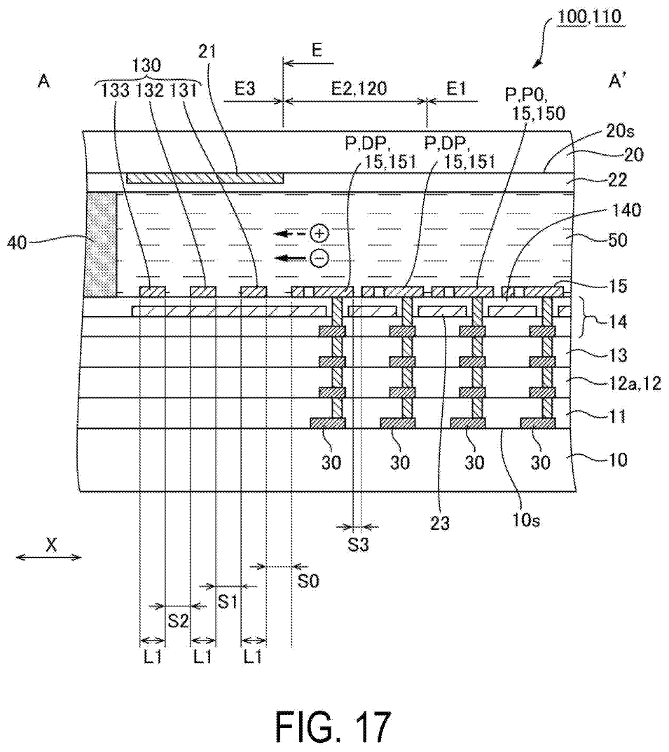

FIG. 17 is an explanatory view of a liquid crystal device 100 according to Fifth Exemplary Embodiment of the present disclosure, and a sectional view schematically illustrating structure of the pixels P. Thus, FIG. 17 corresponds to FIG. 4 referred in First Exemplary Embodiment. While the common electrode 23 is provided on the second substrate 20 in First Exemplary Embodiment, both a pixel electrode 15 and a common electrode 23 are formed on a first substrate 10 in the present exemplary embodiment. More specifically, the common electrode 23 is formed on a wiring layer 14 of the first substrate 10, and an insulating layer 140 is provided between the common electrode 23 and the pixel electrode 15. The pixel electrode 15 is formed with an opening in a slit-like shape, and the pixel electrode 15 and the common electrode 23 apply a driving voltage as a lateral electric field to a liquid crystal layer 50 through the opening. In other words, the liquid crystal device 100 includes a liquid crystal panel 110 of a Fringe Field Switching (FFS) type.

Similar to First Exemplary Embodiment, ion trap electrodes (a first electrode 131, a second electrode 132, and a third electrode 133) are provided in a region between a pixel region E and a sealing material 40, even in the present exemplary embodiment, and when each of signals different in phase are supplied to the corresponding one of the first electrode 131, the second electrode 132, and the third electrode 133, ionic impurities in the pixel region E are swept outside the pixel region E by the first electrode 131, the second electrode 132, and the third electrode 133.

In the present exemplary embodiment, the common electrode 23 is also provided below the first electrode 131, the second electrode 132, and the third electrode 133. Accordingly, when each of signals different in phase are supplied to the corresponding one of the first electrode 131, the second electrode 132, and the third electrode 133, the ionic impurities in the pixel region E are swept outside the pixel region E even by a lateral electric field between each of the first electrode 131, the second electrode 132, and the third electrode 133, and the common electrode 23.

Configuration of Electronic Apparatus

First Configuration Example of Projection-Type Display Device

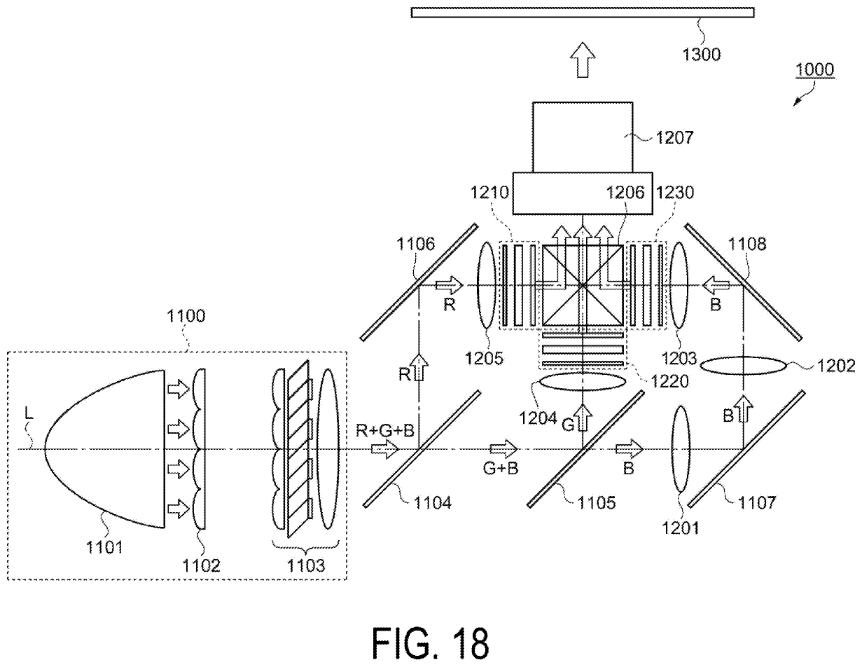

FIG. 18 is an explanatory view illustrating a first configuration example of an electronic apparatus (a projection-type display device) to which the present disclosure is applied. As illustrated in FIG. 18, a projection-type display apparatus 1000 as an electronic apparatus according to the present exemplary embodiment includes a polarized light illumination device 1100 disposed along a system optical axis L, two dichroic mirrors 1104 and 1105 as light separation elements, three reflection mirrors 1106, 1107 and 1108, five relay lenses 1201, 1202, 1203, 1204 and 1205, three transmissive liquid crystal light valves 1210, 1220 and 12303 as optical modulation means, a cross dichroic prism 1206 as a photosynthetic element, and a projection lens 1207. The polarized light illumination device 1100 generally includes a lamp unit 1101 as a light source composed of a white light source such as an extra-high pressure mercury lamp or a halogen lamp, an integrator lens 1102, and a polarization conversion element 1103.

The dichroic mirror 1104 reflects red light (R) of a polarized light flux emitted from the polarized light illumination device 1100, and transmits green light (G) and blue light (B). The other dichroic mirror 1105 reflects the green light (G) transmitted by the dichroic mirror 1104 and transmits the blue light (B). The red light (R) reflected by the dichroic mirror 1104 is reflected by the reflection mirror 1106 and subsequently is incident on the liquid crystal light bulb 1210 via the relay lens 1205. The green light (G) reflected by the dichroic mirror 1105 is incident on the liquid crystal light bulb 1220 via the relay lens 1204. The blue light (B) passing through the dichroic mirror 1105 is incident on the liquid crystal light bulb 1230 via a light guide system composed of the three relay lenses 1201, 1202 and 1203, and the two reflection mirrors 1107 and 1108.

The liquid crystal light bulbs 1210, 1220 and 1230 are each disposed to face an incident surface for the corresponding one of types of color light of the cross dichroic prism 1206. Each of the types of color light incident on the corresponding one of the liquid crystal light bulbs 1210, 1220 and 1230 is modulated based on image information (image signal) and is emitted toward the cross dichroic prism 1206. The cross dichroic prism 1206 includes four rectangular prisms bonded to each other, and is provided in its inner surface with a dielectric multilayer film configured to reflect red light and a dielectric multilayer film configured to reflect blue light that are formed in a cross shape. Three types of color light are synthesized by these dielectric multilayer films, and light representing a color image is synthesized. The synthesized light is projected onto a screen 1300 by the projection lens 1207 as a projection optical system, and an image is enlarged and displayed.

The liquid crystal device 100 including the ion trapping mechanism 130 described above is applied to the liquid crystal light bulb 1210 in which a pair of light-polarizing elements disposed in a crossed-Nicols state is disposed at an interval on the incident side and the emission side of the color light of the liquid crystal device 100. The same applies to the other liquid crystal light bulbs 1220 and 1230.

According to the projection-type display device 1000 described above, the liquid crystal device 100 according to First Exemplary Embodiment or the like is used for each of the liquid crystal light bulbs 1210, 1220 and 1230, so that a display defect caused by ionic impurities is improved to enable the projection-type display device 1000 having excellent display quality to be provided.

Second Configuration Example of Projection-Type Display Device

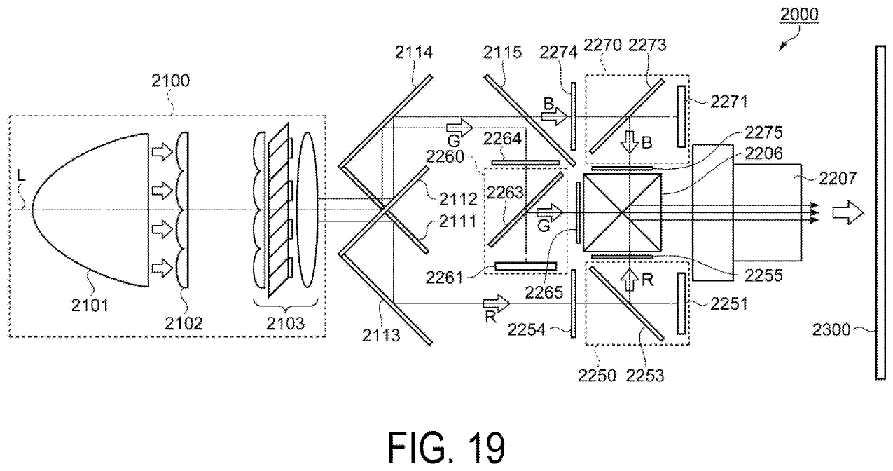

FIG. 19 is an explanatory view illustrating a second configuration example of an electronic apparatus (a projection-type display device) to which the present disclosure is applied. As illustrated in FIG. 19, a projection-type display apparatus 2000 as an electronic apparatus according to the present exemplary embodiment includes a polarized light illumination device 2100 disposed along a system optical axis L, three dichroic mirrors 2111, 2112 and 2115, two reflection mirrors 2113 and 2114, five relay lenses 1201, 1202, 1203, 1204 and 1205, three reflection-type liquid crystal light bulbs 2250, 2260 and 2270 as optical modulation means, a cross dichroic prism 2206, and a projection lens 2207. The polarized light illumination device 2100 generally includes a lamp unit 2101 as a light source composed of a white light source such as a halogen lamp, an integrator lens 2102, and a polarization conversion element 2103.

The polarized illuminating device 2100 emits a polarized light flux that is incident on the dichroic mirror 2111 and dichroic mirror 2112, being disposed orthogonal to each other. The dichroic mirror 2111 as a light separation element reflects red light (R) of the incident polarized light flux. The dichroic mirror 2112 as the other light separation element reflects green light (G) and blue light (B) of the incident polarized light flux. The reflected red light (R) is again reflected by the reflection mirror 2113 to be incident into the liquid crystal light bulb 2250. Meanwhile, the reflected green light (G) and blue light (B) are reflected again by the reflection mirror 2114 to be incident on the dichroic mirror 2115 as a light separation element. The dichroic mirror 2115 reflects the green light (G) and transmits the blue light (B). The reflected green light (G) is incident into the liquid crystal light bulb 2260. The transmitted blue light (B) is incident into the liquid crystal light bulb 2270.

The liquid crystal light bulb 2250 includes a reflective liquid crystal panel 2251, and a wire grid polarization plate 2253 as a reflective polarizing element. The liquid crystal light bulb 2250 is disposed to allow red light (R) reflected by the wire grid polarization plate 2253 to be vertically incident on an incident face of the cross dichroic prism 2206. In addition, an auxiliary polarizer 2254 that compensates for polarization of the wire grid polarization plate 2253 is disposed on an incident side of red light (R) in the liquid crystal light bulb 2250, and the other auxiliary polarization plate 2255 is disposed along the incident face of the cross dichroic prism 2206 on an emission side of the red light (R). When a polarizing beam splitter is used as the reflective polarizing element, the pair of auxiliary polarizing plates 2254 and 2255 may be eliminated.

The reflective liquid crystal light bulb 2250 described above has a configuration and placement of components that are the same as those of the other reflective liquid crystal light bulbs 2260 and 2270. In other words, the liquid crystal light bulb 2260 includes a reflective liquid crystal panel 2261 and a wire grid polarization plate 2263, and the wire grid polarization plate 2263 is provided with its incident side of green light (G) with an auxiliary polarizing plate 2264 and with its emission side of the green light (G) with another auxiliary polarizing plate 2265 disposed along the incident face of the cross dichroic prism 2206.

The liquid crystal light bulb 2270 includes a reflective liquid crystal panel 2271 and a wire grid polarization plate 2273, and the wire grid polarization plate 2273 is provided with its incident side of blue light (B) with an auxiliary polarizing plate 2274 and with its emission side of the blue light (B) with another auxiliary polarizing plate 2275 disposed along the incident face of the cross dichroic prism 2206.

Each of types of color light incident on the corresponding one of the liquid crystal light bulbs 2250, 2260 and 2270 is modulated based on image information, and is again incident on the cross dichroic prism 2206 via the corresponding one of the wire grid polarization plates 2253, 2263 and 2273. In the cross dichroic prism 2206, each of types of color light is synthesized, and the synthesized light is projected onto the screen 2300 through the projection lens 2207, and then an image is magnified and displayed.

In the present exemplary embodiment, the reflective liquid crystal device 100 according to Third Exemplary Embodiment, is used as each of the liquid crystal light bulbs 2250, 2260 and 2270. According to the projection-type display device 2000 as described above, the reflective liquid crystal device 100 is used in each of the liquid crystal light bulbs 2250, 2260 and 2270 to enable a bright image to be projected. In addition, display defects caused by ionic impurities are improved, so that the reflective projection-type display device 2000 having excellent display quality can be provided.

### Other Exemplary Embodiments

The present disclosure is not limited to the exemplary embodiments described above, and may be modified as appropriate within a scope without departing from the scope of claims and the spirit or concept of the disclosure read from the entire specification, and a driving method of the liquid crystal device with such changes, and an electronic apparatus to which the liquid crystal device is applied are also included within the technical scope of the present disclosure. For example, while in the liquid crystal device 100 according to the above-described exemplary embodiment, the dummy pixel region E2 is provided between the demarcation 21 and the display region E1, the present disclosure may be applied when the dummy pixel region E2 overlaps with the demarcation 21 in plan view. The present disclosure may also be applied when the dummy pixel region E2 is not provided between the demarcation 21 and the display region E1.

In addition, an electronic apparatus to which the liquid crystal device 100 according to the present disclosure can be applied is not limited to a projection-type display device, and the liquid crystal device 100 can be used suitably as a projection-type head-up display (HUD), a direct view-type head-mounted display (HMD), an electronic book, a personal computer, a digital still camera, a liquid crystal television, a view finder-type or monitor direct view-type video recorder, a car navigation system, an electronic diary, and an information terminal device such as POS.

What is claimed is:

1. A liquid crystal device comprising:
a first substrate;
a second substrate bonded to the first substrate via a sealing material;
a liquid crystal layer disposed in a space surrounded by the sealing material between the first substrate and the second substrate;
a plurality of pixel electrodes provided in a pixel area in the first substrate;
a first electrode provided at one of the first substrate and the second substrate and supplied with a first signal in an area located between the pixel area and the sealing material in plan view; and
a second electrode provided at the one of the first substrate and the second substrate and supplied with a second signal having a phase different from that of the first signal in an area located between the first electrode and the sealing material in plan view, wherein
a first distance being a distance from a pixel electrode, which is adjacent to the first electrode, among the plurality of pixel electrodes to the first electrode is equal to or less than a second distance from the first electrode to the second electrode.

2. The liquid crystal device according to claim 1, wherein the first distance and the second distance are equal.

3. The liquid crystal device according to claim 1, wherein the first distance and the second distance are greater than a distance between two pixel electrodes adjacent to each other among the plurality of pixel electrodes.

4. The liquid crystal device according to claim 1, wherein a voltage equivalent to ½ times a maximum-voltage amplitude of the first signal and the second signal is equal to or less than a maximum voltage applied across a common electrode and the pixel electrodes.

5. The liquid crystal device according to claim 4, wherein the voltage equivalent to ½ times the maximum-voltage amplitude of the first signal and the second signal is equal to a maximum voltage applied across the common electrode and the pixel electrodes.

6. The liquid crystal device according to claim 1, wherein the first signal and the second signal are alternating signals of a same waveform shape.

7. The liquid crystal device according to claim 1, wherein the one of the first substrate and the second substrate is the first substrate.

8. The liquid crystal device according to claim 7, wherein a common electrode is provided at the second substrate.

9. The liquid crystal device according to claim 8, wherein
the common electrode is provided in an area overlapping with the pixel area in plan view, and
an outer edge of the common electrode is positioned between the pixel area and the first electrode in plan view.

10. The liquid crystal device according to claim 1, wherein the one of the first substrate and the second substrate is provided with a third electrode supplied with a third signal having a phase different from those of the first signal and the second signal in an area located between the second electrode and the sealing material in plan view.

11. The liquid crystal device according to claim 10, wherein
the first signal, the second signal, and the third signal are alternating signals of a same frequency;
after the first signal undergoes transition from a positive polarity or a reference potential to a negative polarity and before the first signal undergoes transition to the reference potential or positive polarity, the second signal undergoes transition from a positive polarity or the reference potential to a negative polarity;
after the second signal undergoes transition to a negative polarity and before the second signal undergoes transition to the reference potential or a positive polarity, the third signal undergoes transition from a positive polarity or the reference potential to a negative polarity;
after the first signal undergoes transition from a negative polarity or the reference potential to a positive polarity and before the first signal undergoes transition to the reference potential or negative polarity, the second signal undergoes transition from a negative polarity or the reference potential to a positive polarity; and
after the second signal undergoes transition from a negative polarity or the reference potential to a positive polarity and before the second signal undergoes transition to the reference potential or a negative polarity, the third signal undergoes transition from a negative polarity or the reference potential to a positive polarity.

12. The liquid crystal device according to claim 10, wherein a third distance from the second electrode to the third electrode is equal to the second distance.

13. An electronic apparatus comprising the liquid crystal device according to claim 1.
